(19) United States
(12) Patent Application Publication
(10) Pub. No.: US 2013/0194625 A1
(43) Pub. Date: Aug. 1, 2013

(54) IMAGE CAPTURING DEVICE

(71) Applicant: PFU Limited, Kahoku-shi (JP)

(72) Inventors: Yasuharu Inami, Kahoku-shi (JP); Mitsuhiro Yashiki, Kahoku-shi (JP)

(73) Assignee: PFU LIMITED, Kahoku-shi (JP)

(21) Appl. No.: 13/683,654

(22) Filed: Nov. 21, 2012

(30) Foreign Application Priority Data
Jan. 26, 2012 (JP) 2012-014501

(51) Int. Cl. H04N 1/04

(52) U.S. Cl. CPC H04N 1/04
USPC 358/1.15

(57) ABSTRACT

Provided are an image capturing device having an image capturing unit which captures an image, a storage unit which stores the captured image, a wireless communication unit which communicates with a wireless communication terminal via a wireless line, and a detection unit which detects a predetermined condition. Further, the image capturing device has a control unit which restricts access from a wireless communication terminal while maintaining communication between the wireless communication unit and the wireless communication terminal when the detection unit detects the predetermined condition.

### CROSS-REFERENCE TO RELATED APPLICATIONS

This application is based upon and claims the benefit of priority of prior Japanese Patent Application No. 2012-014501, filed on Jan. 26, 2012, the entire contents of which are incorporated herein by reference.

### TECHNICAL FIELD

Embodiments discussed in the present specification relate to an image capturing device having a wireless communication unit.

### BACKGROUND

It is known to search various information by using a portable information terminal device. Further, it is also known to convert information that is not electronic information, such a document, into electronic information by using an image pickup device, such as a digital camera, or a facsimile, MFP (Multifunction

Peripheral), or an image capturing device, such as an image reading device, such as a scanner. Furthermore, there is need to covert non-electronic information into electronic information to share the information in various locations not only in a specific space, such as an office.

In order to meet such a need, there are various measures. Firstly, using a personal computer and a scanner, however, it is inconvenient to carry a personal computer. Secondary, converting non-electronic information into electronic information by using a digital camera, however, it is not easy to capture a document by a digital camera. Thirdly, converting non-electronic information into electronic information by using an MFP, however, it is not easy to carry an MFP.

Further, by these measures, if there is not a driver conformant to the image capturing device in a location where a document is converted into electronic information, a conformant driver is installed and network information, such as the IP address of the printer, printer port, and a print protocol to be used is set.

In order to solve these problems, there is a known system in which dedicated driver software to control an image capturing device is installed in a client and thus the need to set the driver software is obviated (for example, see Japanese Laid-open Patent Publication No. 2011-48857). In the system described in Japanese Laid-open Patent Publication No. 2011-48857, the server generates a web page to instruct execution of services for the printer and transmits the web page in response to a request from the web browser. Next, the server receives an HTTP request indicating an instruction to execute services for the printer from the web browser and instructs the printer to execute services in accordance with the HTTP request. Next, the server receives a completion notification or error notification of the services from the printer and transmits the completion notification or error notification to the web browser as an HTTP response for the HTTP request.

### SUMMARY

By adopting the system described in Japanese Laid-open Patent Publication No. 2011-48857, it is possible to convert information into electronic information in various locations and to share the electronic information via a wireless communication line. When sharing electronic information by wireless connecting unit, however, it is desired to switch both simply and quickly the security levels of the wireless communication line between the image capturing device, which is a server, and a client. The reason is that when utilizing a wireless communication line, a state is brought about where any client capable of communication can access, and therefore, when sharing information with high confidentiality, it is desired to restrict the period of time during which communication is available and the clients who are permitted communication.

Accordingly, it is an object of the present invention to provide an image capturing device capable of switching the security levels of a wireless communication line both simply and quickly.

According to an aspect of the device, there is provided an image capturing device having an image capturing unit which captures an image, a storage unit which stores the captured image, a wireless communication unit which communicates with a wireless communication terminal via a wireless line, and a detection unit which detects a predetermined condition. Further, the image capturing device has a control unit which restricts access from a wireless communication terminal while maintaining communication between the wireless communication unit and the wireless communication terminal when the detection unit detects the predetermined condition.

Further, it is preferable for communication information which establishes communication between the wireless communication unit and the wireless communication terminal to be displayed on a case.

Further, it is preferable for the detection unit to include a time measuring unit and for the predetermined condition to be the elapse of a given set period of time.

Further, it is preferable to further have a movable unit capable of moving between a first position where image capturing by the image capturing unit is enabled and a second position where image capturing by the image capturing unit is disabled, for the detection unit to include position detecting unit for detecting the position of the movable unit, and for the predetermined condition to be the movable unit being arranged in the second position.

Further, it is preferable to further have a movable unit capable of moving between a first position where a sheet is transferred to the image capturing unit and a second position where the transfer of a sheet to the image capturing device is blocked, for the detection unit to include position detecting unit for detecting the position of the movable unit, and for the predetermined condition to be the movable unit being arranged in the second position.

Further, it is preferable for the detection unit to include time detecting unit for detecting a period of time during which a button arranged on the case is pressed continuously and for the predetermined condition to be the elapse of a given set period of time.

According to the image capturing device, when the predetermined condition is detected, access from the wireless communication terminal is restricted while maintaining communication between the wireless communication unit and the wireless communication terminal, and therefore, it is made possible to switch the security levels of the wireless communication line both simply and quickly.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a wireless communication system in which an image reading device functions as a server.

FIG. 2A is a perspective view of the image reading device.

FIG. 2B is a perspective view of the image reading device.

FIG. 3A is a section view of the image reading device.

FIG. 3B is a section view of the image reading device.

FIG. 4 is a circuit block diagram of the image reading device.

FIG. 5 is a functional block diagram of a control unit of the image reading device.

FIG. 6 is a flowchart illustrating image reading processing of the image reading device.

FIG. 7 is a circuit block diagram of a portable information terminal device.

FIG. 8 is a functional block diagram of a control unit of the portable information terminal device.

FIG. 9A is a flowchart illustrating communication processing in the wireless communication system in which the image reading device functions as a server.

FIG. 9B is a flowchart illustrating communication processing in the wireless communication system in which the image reading device functions as a server.

FIG. 10A illustrates an example of a display of a display unit of the portable information terminal device.

FIG. 10B illustrates an example of a display of a display unit of the portable information terminal device.

FIG. 11A illustrates another example of a display of the display unit of the portable information terminal device.

FIG. 11B illustrates another example of a display of the display unit of the portable information terminal device.

FIG. 12A is a flowchart illustrating communication processing in the wireless communication system in which the image reading device functions as a server.

FIG. 12B is a flowchart illustrating communication processing in the wireless communication system in which the image reading device functions as a server.

FIG. 13A is a flowchart illustrating communication processing in the wireless communication system in which the image reading device functions as a server.

FIG. 13B is a flowchart illustrating communication processing in the wireless communication system in which the image reading device functions as a server.

FIG. 14 is a diagram illustrating a wireless communication system in which an image pickup device functions as a server.

FIG. 15A is a front view of the image pickup device.

FIG. 15B is a front view of the image pickup device.

FIG. 16 is a circuit block diagram of the image pickup device.

FIG. 17 is a functional block diagram of a control unit of the image pickup device.

FIG. 18 is a flowchart illustrating image pickup processing of the image pickup device.

FIG. 19A is a flowchart illustrating communication processing in the wireless communication system in which the image pickup device functions as a server.

FIG. 19B is a flowchart illustrating communication processing in the wireless communication system in which the image pickup device functions as a server.

### DESCRIPTION OF EMBODIMENTS

An image capturing device will be described below with reference to the drawings. It will, however, be noted that the technical scope of the invention is not limited to the specific embodiments disclosed herein, but extends to the inventions described in the appended claims and their equivalents.

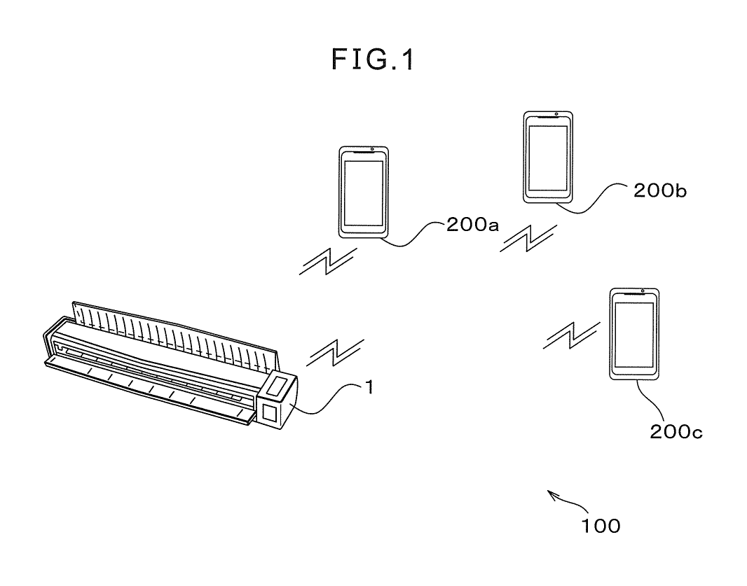

FIG. 1 is a diagram illustrating a wireless communication system 100 in which an image reading device 1 functions as a server. The wireless communication system 100 has the image reading device 1 that functions as a server and a plurality of portable information terminal devices 200a to 200c connected to the image reading device 1 via a wireless communication line and which function as a client. Each of the plurality of the portable information terminal devices 200a to 200c functions as a client having the same functions, and therefore, in the following, explanation is given on the assumption that the plurality of the portable information terminal devices 200a to 200c is generically referred to as a portable information terminal device 200.

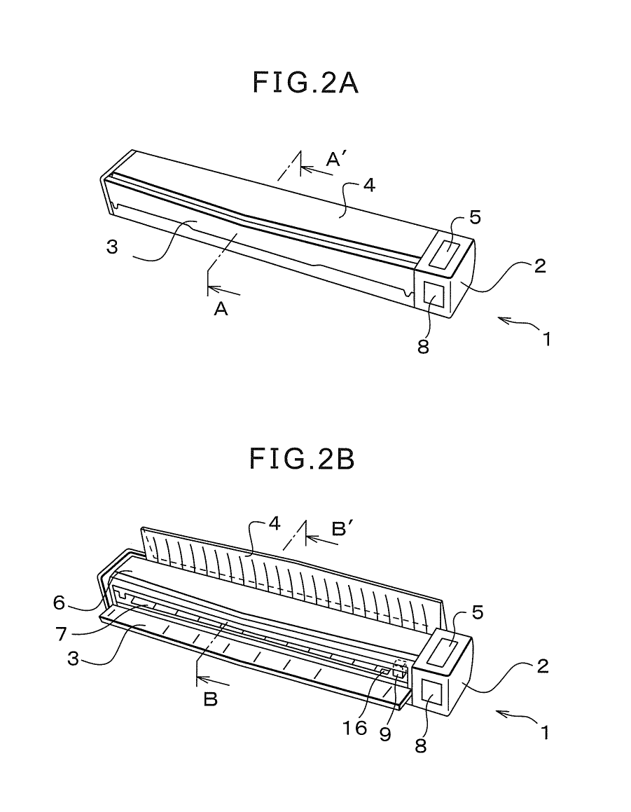

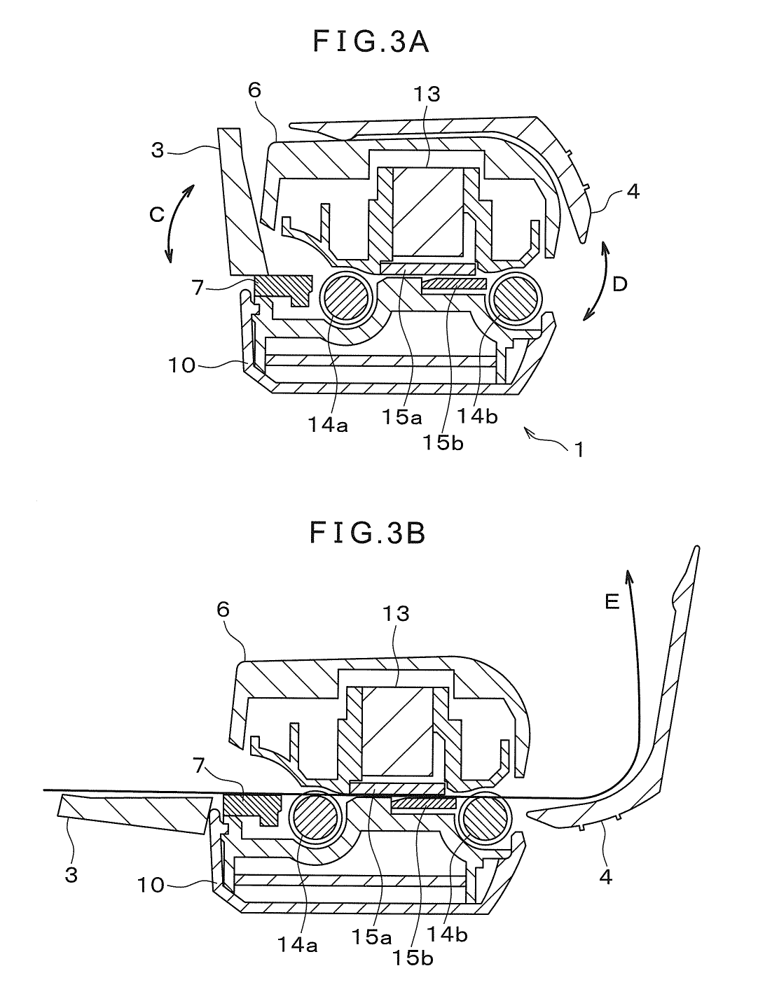

FIG. 2A is a perspective view of the image reading device 1 in the state where the reading function of the image reading device 1 is disabled. FIG. 2B is a perspective view of the image reading device 1 in the state where the reading function of the image reading device 1 is enabled. FIG. 3A is a section view along AA′ of FIG. 2A and FIG. 3B is a section view along BB′ of FIG. 2B.

The image reading device 1 has a case 2, a first paper feed guide 3, a discharge guide 4, an operation button 5, a top cover 5, a second paper feed guide 7, a display unit 8, an open/close detection unit 9, a bottom cover 10, etc. Further, the image reading device 1 has an image reading unit 13, first and second transfer rollers 14a and 14b, an upper guide 15a, a lower guide 15b, a document detection unit 16, etc.

The first paper feed guide 3 is formed of a resin material and engages the case 2 by hinges formed at both ends so as to be of capable of opening and closing as indicated by an arrow C of FIG. 3A. In the state illustrated in FIG. 2B, the first paper feed guide 3 is arranged so as to form an elongated surface together with the second paper feed guide 7, forming a transfer path of a document.

The discharge guide 4 is formed of a resin material and engages the case 2 by hinges formed at both ends so as to be capable of opening and closing as indicated by an arrow D of FIG. 3A. In the state illustrated in FIG. 3A, the discharge guide 4 is arranged in a position in opposition to the top cover 6. In the state illustrated in FIG. 3B, the discharge guide 4 is arranged so as to form a vertical surface, forming a discharge path of a document.

The operation button 5 is arranged on the top surface of the case and when pressed, an operation button being pressed detection signal is generated and transmitted to a control unit 11, to be described later. The control unit 11 having received the operation button being pressed detection signal determines whether to start or exit image reading processing, whether to restrict access to the image reading device 1, whether to cancel restriction of access to the image reading device 1, etc., based on the operation button being pressed detection signal.

The top cover 6 is arranged under the discharge guide 4 and engages with the case 2 by hinges so as to be capable of opening and closing at the time of processing to remove document jam, cleaning of the inside of the image reading device 1, etc.

The display unit 8 has an LCD and is arranged at the end of the front surface of the case 2. On the display unit 8, the QR code (registered trademark) etc. corresponding to communication information, such as an identifier of a network of a wireless communication line, used to establish wireless communication is displayed.

The open/close detection unit 9 has a detection sensor and is arranged in a position in opposition to the first paper feed guide 3 when the first paper feed guide is closed. When the first paper feed guide 3 is closed, the open/close detection unit 9 detects proximity of the first paper feed guide 3 and generates and transmits a first paper feed guide being closed detection signal indicating that the first paper feed guide 3 is closed to the control unit 11.

The image reading unit 13 has a CCD sensor and reads a document sandwiched between the upper guide 15a and the lower guide 15b and generates and outputs an image signal corresponding to the document to the control unit 11.

The first and second transfer rollers 14a and 14b are driven by a motor, not illustrated schematically, and guide an inserted document (not illustrated schematically) between the upper guide 15a and the lower guide 15b and discharges a document read by the image reading unit 13 to the outside through the discharge guide 4. An arrow E of FIG. 3B indicates a transfer path of a document within the image reading device 1.

As illustrated in FIG. 3A, when the first paper feed guide 3 and the discharge guide 4 are closed, it is not possible for the image reading device 1 to transfer a document. That is, the state illustrated in FIG. 3A is a state where the reading function of the image reading device 1 is disabled. On the other hand, as illustrated in FIG. 3B, when the first paper feed guide 3 and the discharge guide 4 are open, it is possible for the image reading device 1 to transfer a document. That is, the state illustrated in FIG. 3B is a state where the reading function of the image reading device 1 is enabled.

The document detection unit 16 has a detection sensor and when a document is arranged on the second paper feed guide 7, detects the document and generates and transmits a document set detection signal to the control unit 11.

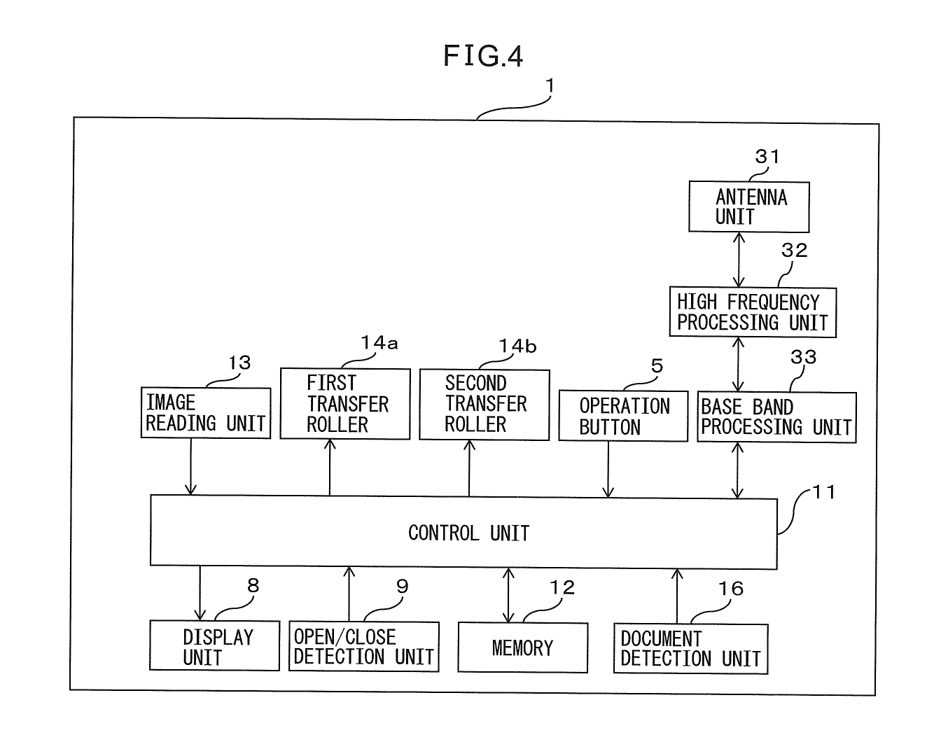

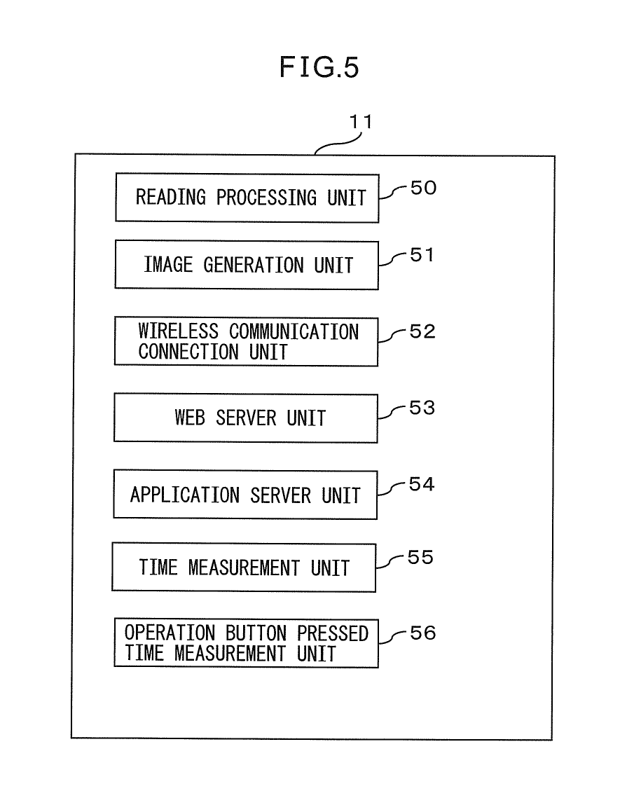

FIG. 4 is a circuit block diagram of the image reading device 1. The image reading device 1 further has an antenna unit 31, a high frequency processing unit 32, a base band processing unit 33, etc.

The control unit 11 controls the operation of the image reading device 1 in accordance with computer programs stored in a memory 12. The computer program may be installed on the control unit 11 from a computer-readable, non-transitory medium such as a compact disk read only memory (CD-ROM), a digital versatile disk read only memory (DVD-ROM), or the like by using a well-known setup program or the like. The control unit 11 includes a CPU (Central Processing Unit) configured to execute image reading programs for the image reading device 1 to read and communication programs for communication via a wireless communication line, and a DSP (digital signal processor). In the memory 12, image reading programs and communication programs are stored. In the memory 12, in addition to the image reading programs and communication programs, data used when executing the programs and image data of a document generated by the control unit 11 are stored. The memory 12 may include a nonvolatile storage device to store image reading programs and a volatile memory to temporarily store data. In another embodiment, there may be included a logic circuit, such as LSI (large scale integration), ASIC (Application Specific Integrated Circuit), and FPGA (Field-Programming Gate Array) to perform image reading processing. It may also be possible to perform part or all of the image reading processing and communication processing explained below by hardware processing.

The antenna unit 31 transmits and receives a wireless signal and the high frequency processing unit 32 converts a base band signal into a wireless signal to be transmitted and at the same time, converts a received wireless signal into a base band signal. The base band processing unit 3 converts a base band signal into a digital signal and vice versa.

FIG. 5 is a functional block diagram of the control unit 11 of the image reading device 1. The control unit 11 has a reading processing unit 50, an image generation unit 51, a wireless communication connection unit 52, a web server unit 53, an application server unit 54, a time measurement unit 55, and an operation button pressed time measurement unit 56. The processing by these components 50 to 56 is performed by the control unit 11 executing the image reading programs and communication programs stored in the memory 12, respectively. FIG. 5 mainly illustrates functions relating to the following explanation. Consequently, it may also be possible for the control unit 11 to include components other than the components illustrated schematically.

The reading processing unit 50 drives hardware, such as the image reading unit 13 and the first and second transfer rollers 14a and 14b, and controls the operation of the image reading device 1 when reading a document. The image generation unit 51 generates image data from an output signal from the image reading unit 13.

The wireless communication connection unit 52 establishes and maintains wireless communication connection with a wireless communication terminal, such as a portable information terminal device, by transmitting and receiving the beacon signal thereto and therefrom. The beacon signal is a signal transmitted at fixed intervals from equipment conformant to the IEEE 802.11 series, such as equipment to which the WiFi (registered trademark) indication is attached, and includes ESSID (Extended Service Set Identification Data), which is an identifier of the network. The system of the wireless communication connection specifies two systems, i.e., the passive scan system and the active scan system. In the passive scan system, communication connection processing is started by a wireless access point, i.e., a server, transmitting the beacon signal. On the other hand, in the active scan system, communication connection processing is started by a communication connection request from a client.

The web server unit 53 receives an HTTP request signal from the web browser of a wireless communication terminal via a wireless communication line. The web server unit 53 having received the HTTP request signal transmits a processing request signal corresponding to the received HTTP request signal to the application server unit 54. The application server unit 54 having received the processing request signal performs processing in accordance with the processing request signal. The application server unit 54 returns a response information signal corresponding to response information generated by performing the processing to the web server unit 53. The web server unit 53 receives the response information signal from the application server unit 54 and transmits an HTTP response information signal corresponding to the received response information signal to the web browser of the wireless communication terminal.

The web server 53 has three modes, that is, the normal mode, the complete access control mode, and the partial access control mode. When an access control transition condition is established, the web server unit 53 makes transition from the normal mode to the complete access control mode or to the partial access control mode. As the condition under which transition is made from the normal mode to the access control mode, mention is made of the reception of a first paper feed guide being closed detection signal by the control unit 11, the elapse of a fixed period of time after reading processing is performed, and the operation button 5 being pressed and held continuously for a fixed period of time. Whether the web server unit 53 makes transition to the complete access control mode or to the partial access control mode is set in an access restriction table stored in the memory 12. It is also possible to set the kinds of access restricted in the partial access control mode in the access restriction table. The setting of the access restriction table is performed by reading an access restriction setting sheet etc.

When the web server unit 53 makes transition to the complete access control mode, the web server unit 53 restricts all the access from the wireless communication terminal. When the web server unit 53 restricts all the access from the wireless communication terminal, the web server unit 53 stops the function. As a result, the image reading device 1 stops functioning as a server.

On the other hand, when the web server unit 53 makes transition to the partial access control mode, the web server unit 53 transmits an HTTP access restricted image signal when accessed from the wireless communication terminal.

The time measurement unit 55 measures the time from the completion of the image reading processing by the reading processing unit 50 and generates an access restriction standby time elapse signal when a predetermined access restriction standby time elapses.

The operation button pressed time measurement unit 56 measures the time from the detection of that the operation button 5 is pressed based on the operation button being pressed detection signal and generates an operation button pressed time elapse signal when a predetermined period of time elapses. The control unit 11 cumulatively adds the number of generated operation button pressed time elapse signals and stores the result in the memory 12 as information of number of times operation button is pressed. When the information of number of times operation button is pressed indicates an odd number, the control unit 11 causes the web server unit 53 to make transition to the complete access control mode or the partial access control mode. When the information of number of times operation button is pressed indicates an even number, the control unit 11 causes the web server unit 53 to make transition to the normal mode. As a result, when the web server unit 53 is in the normal mode, if the operation button pressed time elapse signal is generated, the control unit 11 causes the web server unit 53 to make transition from the normal mode to the complete access control mode or to the partial access control mode. On the other hand, when the web server unit 53 is in the complete access control mode or in the partial access control mode, if the operation button pressed time elapse signal is generated, the control unit 11 causes the web server unit 53 to make transition from the complete access control mode or from the partial access control mode to the normal mode.

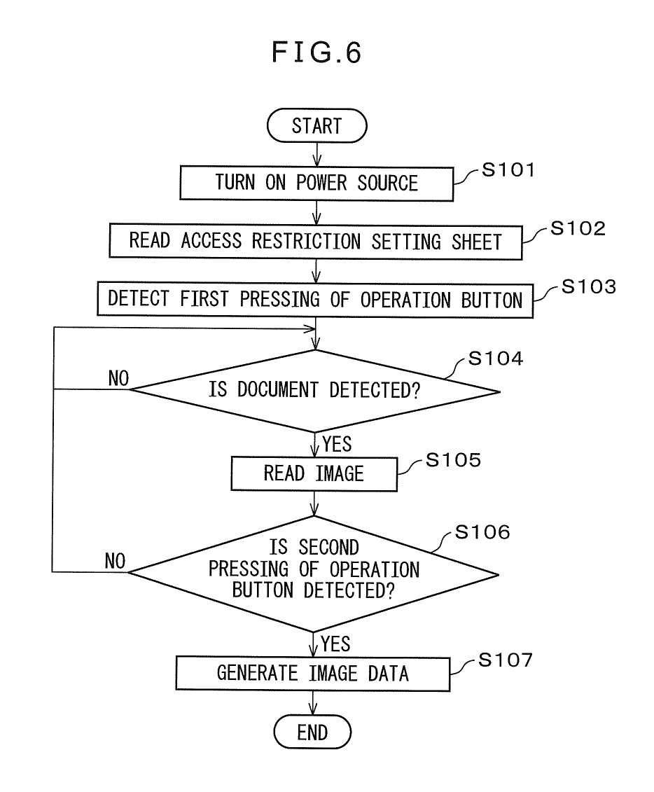

With reference to FIG. 6, the image reading processing by the image reading device 1 is explained. FIG. 6 is a flowchart illustrating the image reading processing by the image reading device 1. The flow illustrated in FIG. 6 is performed by the control unit 11 of the image reading device 1 by executing computer programs stored in the memory 12 of the image reading device 1.

First, in step S101, the power source of the image reading device 1 is turned on. When the power source is turned on, the image reading device 1 initializes data of a read counter, a built-in timer, an image processing work memory, etc., stored in the memory 12.

Next, in step S102, the image reading device 1 reads an access restriction setting sheet. On the access restriction setting sheet, a recognition indication with which the image reading device 1 recognizes the access restriction setting sheet and various pieces of setting data are displayed. The setting data includes the kinds of the access restriction mode and the kinds of access restricted in the partial access control mode. Further, the setting data includes the period of time from when the reading processing is performed to the transition to the access restriction mode, the period of time during which the operation button 5 is pressed and held to switch modes of the web server unit 53, etc. When the setting relating to the access restriction is not changed, it is possible to omit the processing of step S102.

Next, in step S103, the image reading device 1 detects that an operator presses the operation button 5. The image reading device 1 enters the reading state by detecting first pressing of the operation button 5.

Next, in step S104, the image reading device 1 determines whether or not a document is arranged on the second paper feed guide 7. When the image reading device 1 determines that a document is arranged on the second paper feed guide 7, the processing proceeds to step S105. On the other hand, when the image reading device 1 determines that no document is arranged on the second paper feed guide 7, the processing returns to step S104. The control unit 11 determines whether or not a document is arranged on the second paper feed guide 7 based on whether or not a document set detection signal is received from the document detection unit 16.

When the image reading device 1 determines that a document is arranged on the second paper feed guide 7, the image reading device 1 causes the reading processing unit 50 to function to read the document in step S105.

Next, in step S106, the image reading device 1 determines whether or not the operator presses the operation button 5 again. This determination is performed for the image reading device 1 to exit the reading state by detecting second pressing of the operation button 5. When it is determined that the operation button 5 is not pressed again, the processing returns to step S104. When it is determined that the operation button 5 is pressed again, the processing proceeds to step S107.

Then, in step S107, the image reading device 1 causes the image generation unit 51 to function to generate image data.

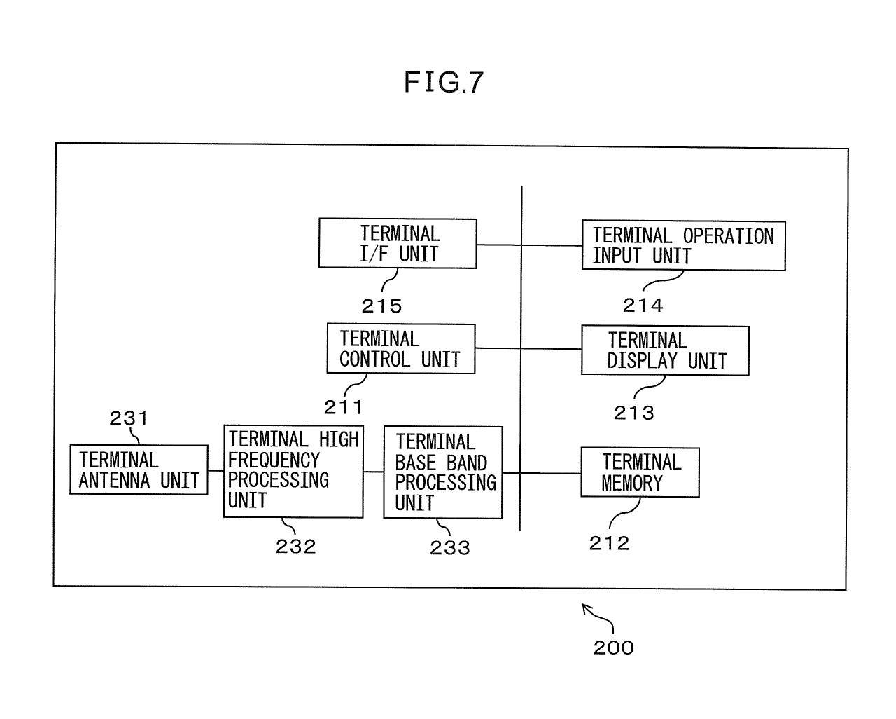

FIG. 7 is a circuit block diagram of the portable information terminal device 200 included in the wireless communication system 100. The portable information terminal device 200 has a terminal control unit 211, a terminal memory 212, a terminal display unit 213, a terminal operation input unit 214, and a terminal interface unit 215. The portable information terminal device 200 further has a terminal antenna unit 231, a terminal high frequency processing unit 232, and a terminal base band processing unit 233.

The terminal control unit 211 controls the operation of the portable information terminal device 200 in accordance with computer programs stored in the terminal memory 212. The terminal control unit 211 includes a CPU configured to execute communication programs for the portable information terminal device 200 to perform communication via a wireless communication line, and a DSP. In the terminal memory 212, communication programs are stored. In the terminal memory 212, in addition to the communication programs, data used at the time of execution thereof and image data acquired from the image reading device 1 via a wireless communication line are stored. It may also be possible for the terminal memory 212 to include a nonvolatile storage device for storing communication programs and a volatile memory for temporarily storing data. In another embodiment, there may be included a logic circuit, such as an LSI and ASIC, to perform image reading processing. It may also be possible to perform part or the whole of the communication processing to be explained below by hardware processing.

The terminal display unit 213 is an LCD formed at the front part of the portable information terminal device 200 and displays an image acquired from the image reading device 1 via a wireless communication line and at the same time, displays part of the functions of the terminal operation input unit 214 as software buttons displayed on a GUI. By detecting an output signal of a transparent touch panel provided on the surface of the terminal display unit 213, the input by the operation of the software button is received.

The terminal operation input unit 214 receives an input signal generated by the operation of an operator. The terminal interface unit 215 is a wired communication interface between the portable information terminal device 200 and another device. It is possible for the portable information terminal device 200 to transmit image data acquired from the image reading device 1 to a personal computer (not illustrated schematically) via the terminal interface unit 215.

The terminal antenna unit 231 transmits and receives a wireless signal to and from the image reading device 1 and the terminal high frequency processing unit 232 converts a base band signal into a wireless signal to be transmitted to the image reading device 1 and at the same time, converts a wireless signal received from the image reading device 1 into a base band signal. The terminal base band processing unit 233 converts a base band signal into a digital signal and vice versa.

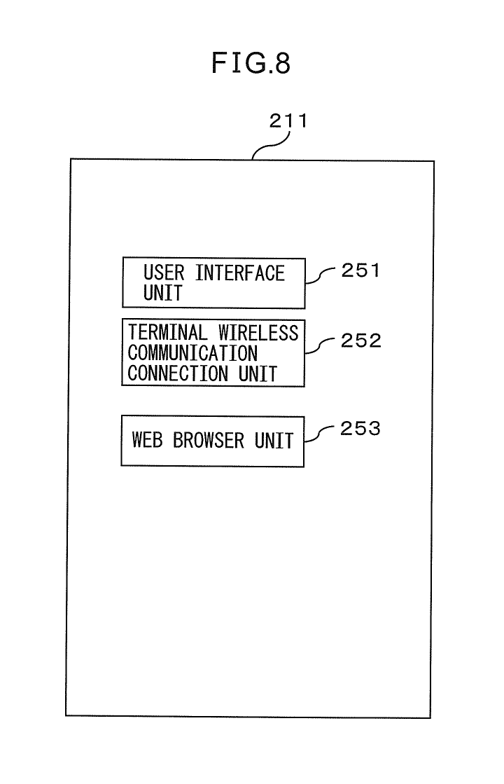

FIG. 8 is a functional block diagram of the terminal control unit 211 of the portable information terminal device 200. The terminal control unit 211 includes a user interface unit 251, a terminal wireless communication connection unit 252, and a web browser unit 253. The processing by these components 251 to 253 is performed by the terminal control unit 211 executing communication programs stored in the terminal memory 212. FIG. 8 mainly illustrates functions relating to the following explanation. As a result, it may also be possible for the terminal control unit 211 to include components other than the components illustrated schematically.

The user interface unit 251 is a program configured to intermediate between the portable information terminal device 200 and the operation of an operator when the operator performs various operations or settings for the portable information terminal device 200. The user interface unit 251 transfers operation information to the various programs stored in the terminal memory 212 in accordance with the operation information of the operator input via the terminal operation input unit 214, and thereby, makes a request to execute processing in accordance therewith, sets data, etc.

The terminal wireless communication connection unit 252 establishes and maintains wireless communication connection with the image reading device 1 by transmitting and receiving the beacon signal thereto and therefrom.

The web browser unit 253 is a program configured to establish HTTP connection with the web server unit 53 of the image reading device 1 via a wireless communication line to execute various kinds of processing provided by the image reading device 1. The web browser unit 253 receives an input by an operator input from the terminal operation input unit 214 and transmits an operator input signal corresponding to the operator input to the web server unit 53 of the image reading device 1. Further, the web browser unit 253 converts a signal received from the web server unit 53 of the image reading device 1 into data that can be stored by the terminal memory 212 via the user interface unit 251 and stores the converted data in the terminal memory 212.

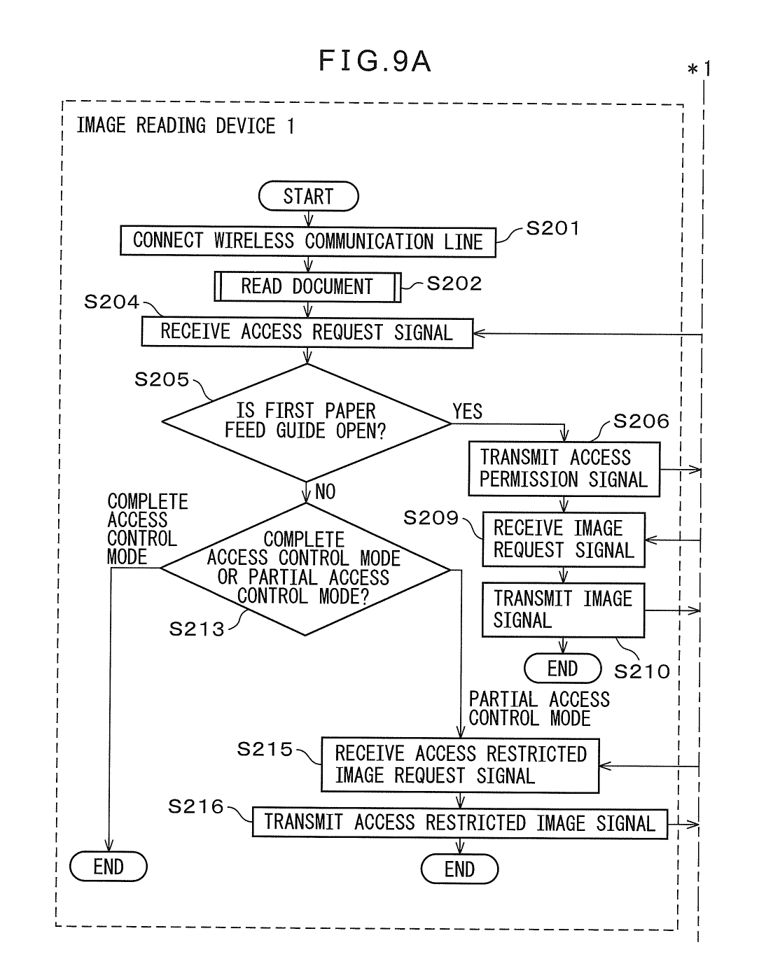

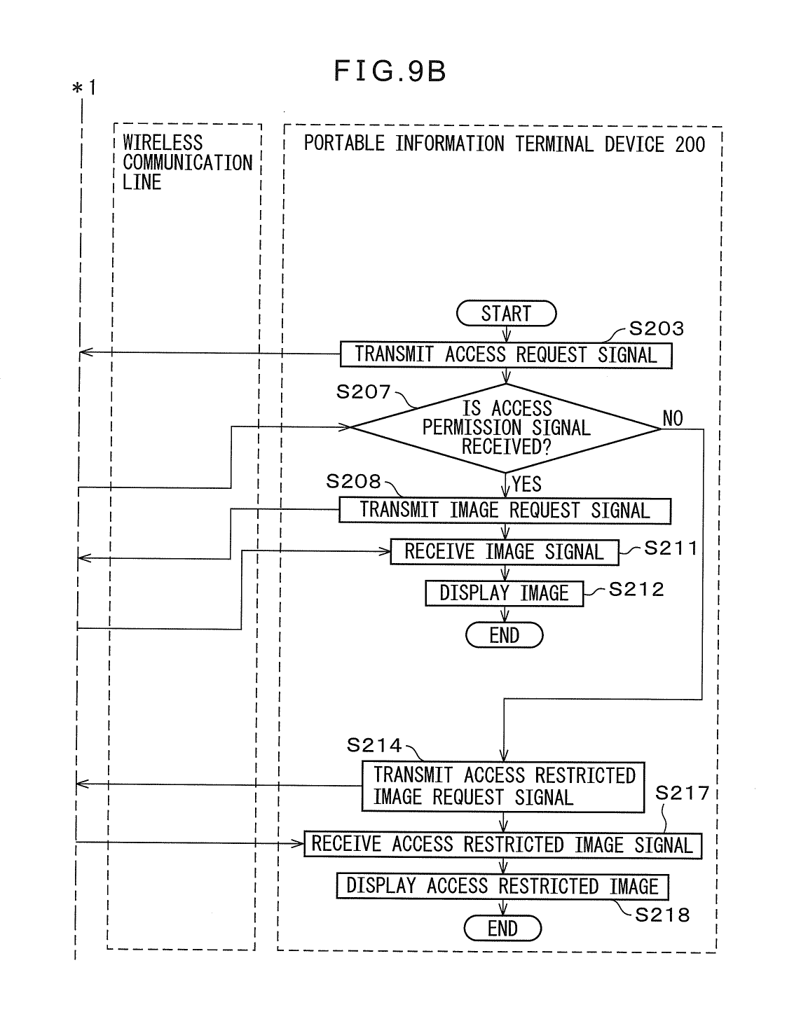

With reference to FIGS. 9A and 9B, the communication processing in the wireless communication system 100 in which the image reading device 1 functions as a server and the portable information terminal device 200 as a client. FIGS. 9A and 9B are a flowchart of the communication processing in the wireless communication system 100. The flow illustrated in FIGS. 9A and 9B is performed by the control unit 11 of the image reading device 1 and the terminal control unit 211 of the portable information terminal device 200 performing corresponding processing, respectively, by executing the computer programs stored in the memory 12 of the image reading device 1 and in the terminal memory 212 of the portable information terminal device 200, respectively.

First, in step S201, the image reading device 1 connects a wireless communication line with the portable information terminal device 200. The portable information terminal device 200 receives the beacon signal transmitted from the image reading device 1 to confirm that the quality of the wireless communication line with the image reading device 1 as an access point is stable and also to confirm that the image reading device 1 is a server. Next, the portable information terminal device 200 makes a request for authentication to the image reading device 1 and the image reading device 1 confirms whether or not the portable information terminal device 200 is authenticated as a client of the wireless communication line with the image reading device 1 as an access point. Next, the image reading device 1 and the portable information terminal device 200 exchange SSIDs of their own in order to establish a relationship between server and client. Then, the image reading device 1 registers the SSID of the portable information terminal device 200 in a management table, and thus, the communication processing of the wireless communication line between the image reading device 1 and the portable information terminal device 200 is completed. The connection processing described above is performed between the wireless communication connection unit 52 of the image reading device 1 and the terminal wireless communication connection unit 252 of the portable information terminal device 200. After the connection processing is completed, each of the image reading device 1 and the portable information terminal device 200 continues transmission and reception of the beacon signal in a predetermined period.

Next, in step S202, the image reading device 1 reads a document in accordance with the image reading processing flow illustrated in FIG. 6.

Next, in step S203, the portable information terminal device 200 transmits an access request signal. The portable information terminal device 200 detects that a software button displayed as “Browse” on the terminal display unit 213 is pressed by an operator and transmits an HTTP access request signal via the user interface unit 251 and the web browser unit 253.

Next, in step S204, the image reading device 1 receives the access request signal. The web server unit 53 receives the HTTP access request signal and transmits the corresponding access request signal to the application server unit 54. The application server unit 54 generates access request information based on the transmitted access request signal.

Next, in step S205, the image reading device 1 determines whether or not the first paper feed guide 3 is open. The control unit 11 determines whether or not the first paper feed guide being closed detection signal is received from the open/close detection unit 9. When the control unit 11 has not received the first paper feed guide being closed detection signal yet from the open/close detection unit 9, it is determined that the first paper feed guide 3 is open and the processing proceeds to step S206. On the other hand, when the control unit 11 has received the first paper feed guide being closed detection signal from the open/close detection unit 9, it is determined that the first paper feed guide 3 is closed and the processing proceeds to step S213.

When it is determined that the first paper feed guide 3 is open, the image reading device 1 transmits an access permission signal in step S206. The application server unit 54 transmits the access permission signal to the web server unit 53. Next, the web server unit 53 transmits an HTTP access permission signal corresponding to the access permission signal to the web browser unit 253 of the portable information terminal device 200.

Next, in step S207, the portable information terminal device 200 determines whether or not the access permission signal is received during a predetermine access permitted time from the image reading device 1. When the portable information terminal device 200 has received the access permission signal from the image reading device 1 during the predetermined access permitted time, the portable information terminal device 200 determines that the image reading device 1 has permitted the access and the processing proceeds to step S208. On the other hand, when the portable information terminal device 200 has not received the access permission signal from the image reading device 1 during the predetermined access permitted time, the portable information terminal device 200 determines that the image reading device 1 has restricted the access and the processing proceeds to step S214.

In step S207, when the portable information terminal device 200 determines that the access has been permitted, the portable information terminal device 200 transmits an image request signal to the image reading device 1 in step S208. The portable information terminal device 200 transmits an HTTP image request signal via the user interface unit 251 and the web browser unit 253.

Next, in step S209, the image reading device 1 receives the image request signal from the portable information terminal device 200. The web server unit 53 receives the HTTP image request signal and transmits the corresponding image request signal to the application server unit 54. Next, the application server unit 54 to which the image request signal is transmitted accesses one or a plurality of pieces of image data stored in the memory 12.

Next, in step S210, the image reading device 1 transmits one or a plurality of image signals to the portable information terminal device 200. The application server unit 54 transmits the one or plurality of pieces of image data to the web server unit 53. Next, the web server unit 53 transmits HTTP image data corresponding to the image data to the web browser unit 253 of the portable information terminal device 200.

Next, in step S211, the portable information terminal device 200 receives an HTTP image signal. The web browser unit 253 having received the HTTP image data stores the corresponding image data in the terminal memory 212 via the user interface unit 251.

Next, in step S212, the portable information terminal device 200 displays the image on the terminal display unit 213. The user interface unit 251 converts the image data stored in the terminal memory 212 into data that can be displayed on the terminal display unit 213 and displays the image on the terminal display unit 213.

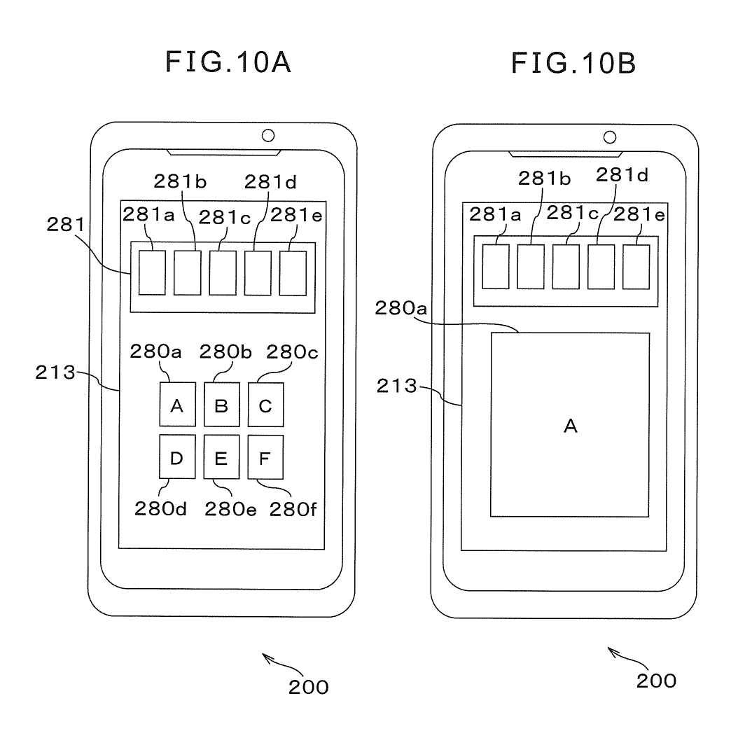

FIG. 10A illustrates a display screen including an image displayed on the terminal display unit 213 in step S212. In FIG. 10A, on the terminal display unit 213, images 280a to 280f and a software button unit 281 are displayed.

The images 280a to 280f are images corresponding to the image data stored in the memory 12 of the image reading device 1. The images 280a to 280f are selected and displayed by being pressed by an operator. FIG. 108 illustrates a diagram in which the image 280a is pressed by an operator and selected and displayed. It is possible for the operator to change the display state in a variety of ways by appropriately touching the image 280a illustrated in FIG. 10B. For example, by touching the image 280a continuously from right to left, the next page can be displayed.

In the software button unit 281, a setting button 281a, a download button 281b, a content button 281c, a delete button 281d, and a list switch button 281e are displayed. These software buttons function to perform predetermined functions by being pressed by an operator.

By pressing the setting button 281a, it is possible to change various settings via a change screen on which to change the setting inside of the image reading device 1, or a change screen on which to change the setting of the wireless communication line, etc.

By pressing the download button 281b, it is possible to download the image data of the image currently selected and displayed from the memory 12 of the image reading device 1 to the terminal memory 212 of the portable information terminal device 200.

By pressing the content button 281c, it is possible to edit the image data inside of the memory 12 of the image reading device 1 corresponding to the image currently selected and displayed. Edition of the image currently selected and displayed includes cutting-out of the image, exchange of image pages, creation of a document by putting a plurality of images together, etc. For example, by pressing the content button 281c in the state illustrated in FIG. 10B, the image 280a can be edited.

By pressing the delete button 281d, it is possible to delete the image data corresponding to the image currently selected and displayed from the memory 12 of the image reading device 1. For example, by pressing the delete button 281d in the state illustrated in FIG. 10B, the image 280a can be deleted.

By pressing the list switch button 281e, it is possible to switch the image currently displayed to a text character display. For example, by pressing the list switch button 281e in the state illustrated in FIG. 10A, it is possible to switch the displays of the images 280a to 280f to displays of text corresponding to the images 280a to 280f, respectively.

Next, a case is explained where the image reading device 1 determines that the first paper feed guide 3 is closed in step S205. Referring to FIGS. 9A and 9B again, in step S213, the image reading device 1 determines whether the web server unit 53 is in the complete access restriction mode or in the partial access restriction mode.

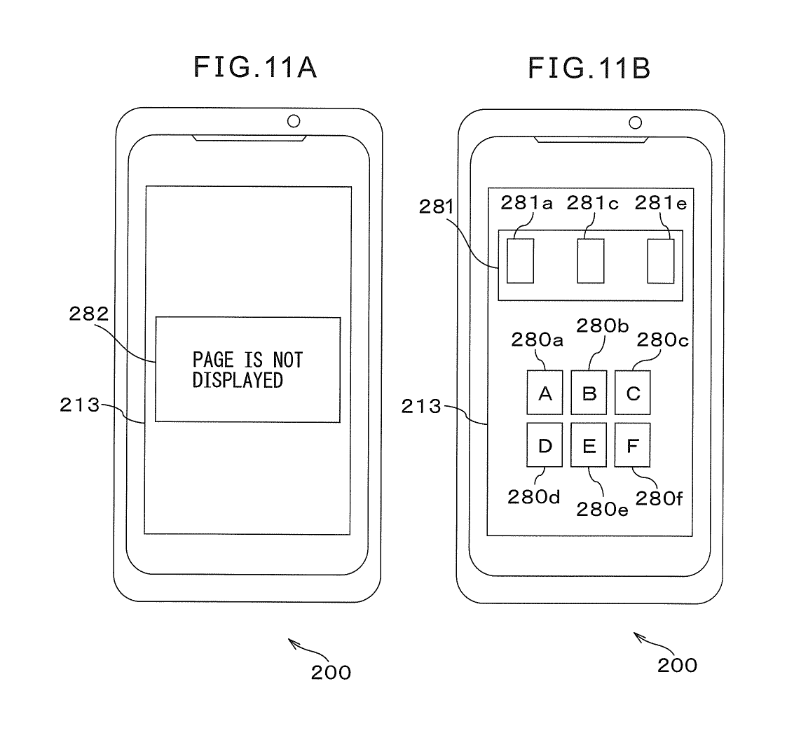

When it is determined that the web server unit 53 is in the complete access restriction mode in step S213, the image reading device 1 exits the processing. Since the image reading device 1 has exited the processing, the image reading device 1 no longer functions as a server, and therefore, it is not possible for the portable information terminal device 200 to acquire image data. As a result, it is not possible for the portable information terminal device 200 to receive a response signal for an access restricted image request signal, to be explained later. Consequently, as illustrated in FIG. 11A, after a predetermined response standby time elapses, a page undetected display 282 indicating that the page is not displayed is displayed on the terminal display unit 213. Page undetected display image data corresponding to the page undetected display 282 is stored in the terminal memory 212 of the portable information terminal device 200. However, in this case also, the wireless communication connection unit 52 of the image reading device 1 and the terminal wireless communication connection unit 252 of the portable information terminal device 200 continue to function, respectively, and therefore, the image reading device 1 maintains communication with the portable information terminal device 200.

When it is determined that the web server unit 53 is in the partial access restriction mode in step S213, the image reading device 1 stands by until receiving the access restricted image request signal in step S215.

On the other hand, the portable information terminal device 200 does not receive an access permission signal in the partial access control mode, and therefore, after the predetermined access permitted time in step S207 elapses, the processing proceeds to step S214. Next, in step S214, the portable information terminal device 200 transmits an access control image request signal to the image reading device 1.

Next, in step S215, the image reading device 1 receives the access control image request signal. The application server unit 54 having received the access control image request signal accesses the access restricted image data stored in the memory 12.

Next, in step S216, the image reading device 1 transmits an access control image signal. The application server unit 54 transmits the access restricted image data to the web server unit 53. Next, the web server unit 53 transmits an HTTP access restricted image signal including HTTP access restricted image data corresponding to the access restricted image data to the web browser unit 253 of the portable information terminal device 200.

Next, in step S217, the portable information terminal device 200 receives the access restricted image signal. The web browser unit 253 having received the HTTP access restricted image signal including the HTTP access restricted image data stores the corresponding access restricted image data in the terminal memory 212.

Next, in step S218, the portable information terminal device 200 displays the access restricted image. The user interface unit 251 converts the access restricted image data stored in the terminal memory 212 into data that can be displayed on the terminal display unit 213 and displays the access restricted image on the terminal display unit 213.

FIG. 11B illustrates an example of a display screen including an access restricted image displayed on the terminal display unit 213 in step S218. The download button 281b and the delete button 281d are not displayed on the terminal display unit 213. As a result, it is not possible for an operator who uses the portable information terminal device 200 to perform the download function or the delete function as a result. The type of access restricted by the partial access restriction mode include other functions that can be processed by access from the portable information terminal device 200, such as the editing function, not only the download function and the delete function. As described above, in the partial access control mode, it is possible to restrict any one of accesses by selecting an image to be displayed on the terminal display unit 213 of the portable information terminal device 200.

As above, with reference to FIGS. 9A and 9B, the communication flow in the wireless communication system 100 in which the image reading device 1 functions as a server is explained. The image reading device 1 restricts access and cancels access restriction with the portable information terminal device 200 while maintaining the wireless communication line with the portable information terminal device 200 in accordance with the open or closed state of the first paper feed guide 3. As a result, when intending to restrict access with the portable information terminal device 200, an operator only close the first paper feed guide 3 of the image reading device 1. On the other hand, when intending to cancel access restriction with the portable information terminal device 200, it is possible for the operator to cancel the access restriction by opening the first paper feed guide 3 of the image reading device 1 without requiring additional work or the communication setting time for the second time communication setting. In this manner, in the image reading device 1, it is possible to switch the security levels of access with the portable information terminal device 200 both simply and quickly.

In the flow explained with reference to FIGS. 9A and 9B, access is restricted and access restriction is cancelled in accordance with the open or closed state of the first paper feed guide 3 of the image reading device 1. However, it is also possible for the image reading device 1 to select settings so that access can be restricted and access restriction can be cancelled by other means. It is possible for an operator to make settings so as to cause only one of the three functions to function, i.e., the function to restrict access and the function to cancel access restriction. Further, it is possible for an operator to make settings so as to cause any two of or all the three functions to function, i.e., the function to restrict access and the function to cancel access restriction.

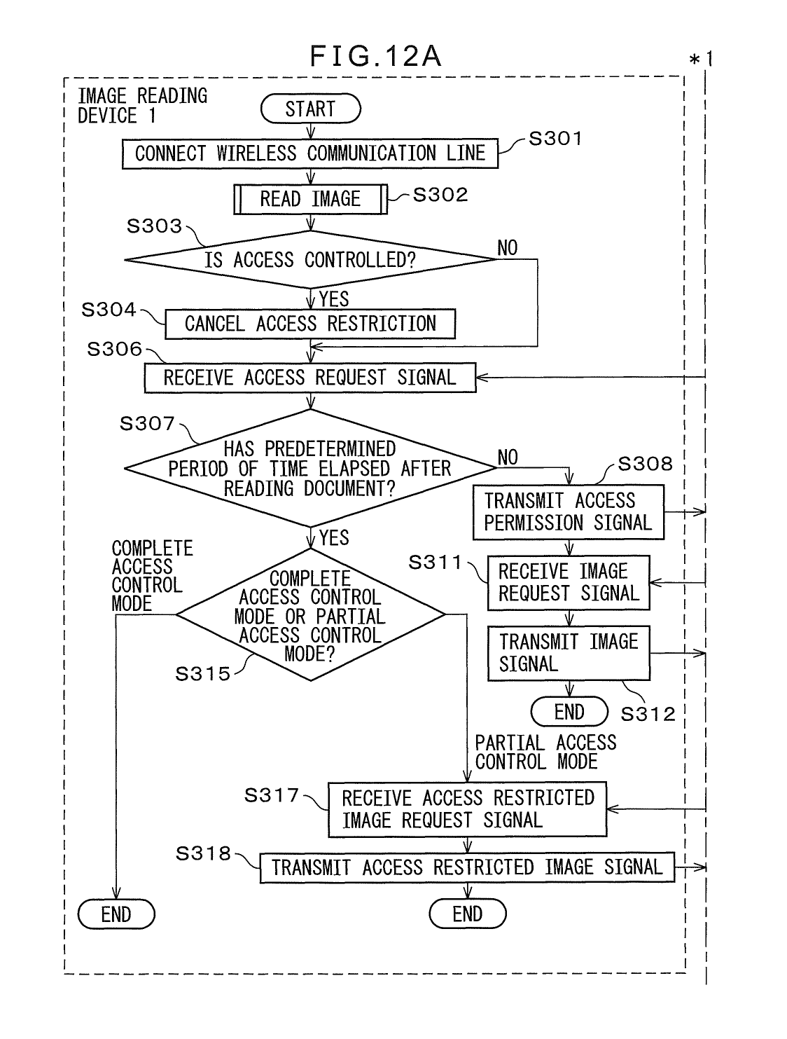

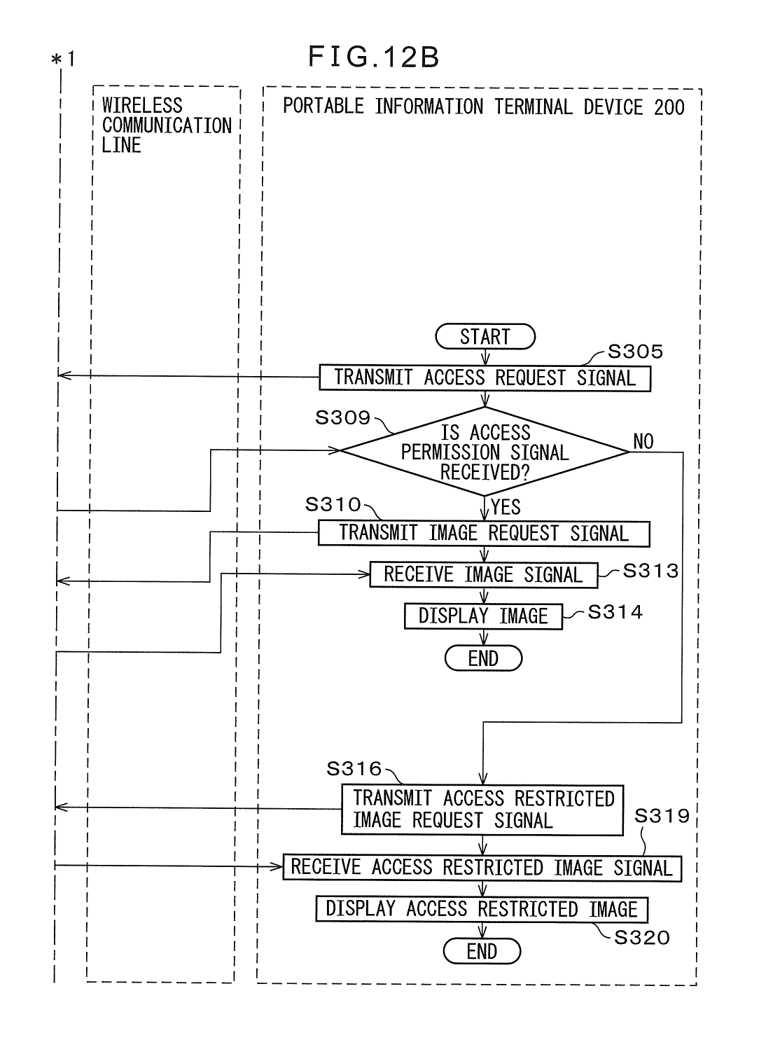

FIGS. 12A and 12B are a flowchart when access is restricted after a fixed period of time elapses after performing reading processing in the wireless communication system 100. The flow illustrated in FIGS. 12A and 12B is performed by the control unit 11 of the image reading device 1 and the terminal control unit 211 of the portable information terminal device 200 performing corresponding processing, respectively, by executing the computer programs stored in the memory 12 of the image reading device 1 and in the terminal memory 212 of the portable information terminal device 200, respectively. S308 to S320 correspond to steps S206 to S218 of the flow illustrated in FIGS. 9A and 9B, and therefore, explanation thereof is omitted here.

First, in step S301, the image reading device 1 connects a wireless communication line with the portable information terminal device 200.

Next, in step S302, the image reading device 1 reads a document in accordance with the image reading processing flow illustrated in FIG. 6.

Next, in step S303, the image reading device 1 determines whether or not access is restricted. When the image reading device 1 determines that access is restricted, the processing proceeds to step S304. On the other hand, when the image reading device 1 determines that access restriction is cancelled, the processing proceeds to step S305.

When it is determined that access is restricted, the image reading device 1 cancels access restriction in step S304.

Next, in step S306, the image reading device 1 receives an access request signal transmitted from the portable information terminal device 200 in step S305.

Next, in step S307, the image reading device 1 determines whether or not a predetermined access restriction standby time has elapsed after the image reading processing illustrated in step S302 is performed. The time measurement unit 55 measures time from when the image reading processing by the reading processing unit 50 in step S302 is completed. When the predetermined access restriction standby time has elapsed, the time measurement unit 55 generates an access restriction standby time elapse signal. When the access restriction standby time elapse signal is not generated, the image reading device 1 determines that the predetermined access restriction standby time has not elapsed yet and the processing proceeds to step S308. On the other hand, when the access restriction standby time elapse signal is generated, the image reading device 1 determines that the predetermined access restriction standby time has elapsed and the processing proceeds to step 315.

As described above, in the flow illustrated in FIGS. 12A and 12B, the image reading device 1 restricts access when the predetermined access restriction standby time elapses after reading a document. Further, the image reading device 1 cancels access restriction by reading a new document in the access restricted state. As a result, in the flow illustrated in FIGS. 12A and 12B, it is possible for the image reading device 1 to simply switch the security levels of access with the portable information terminal device 200.

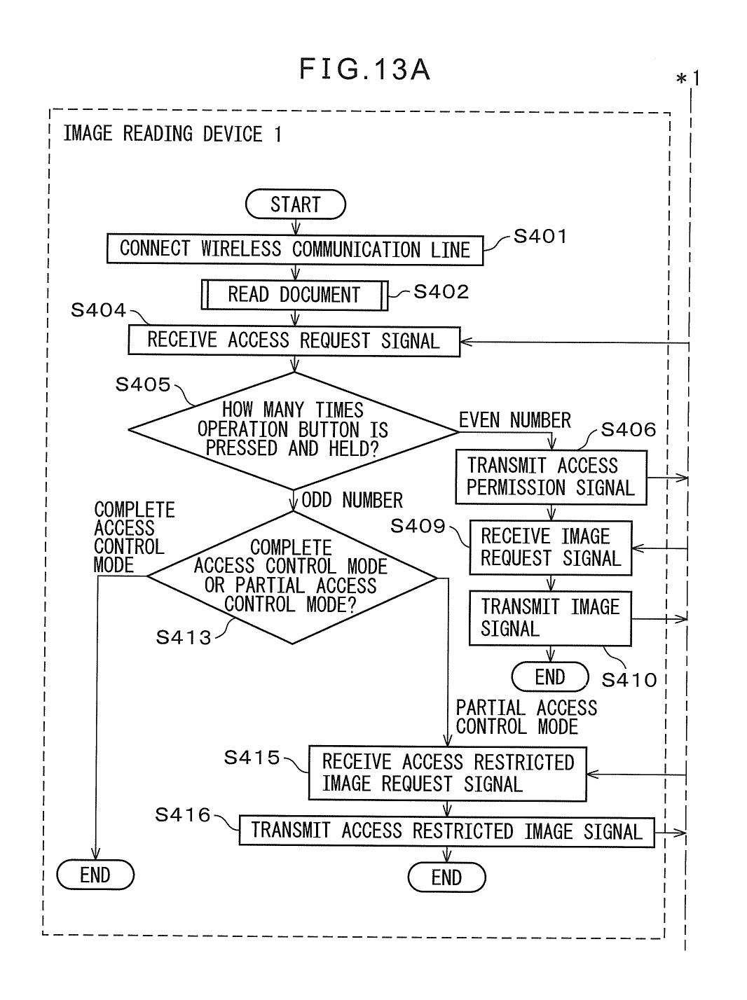

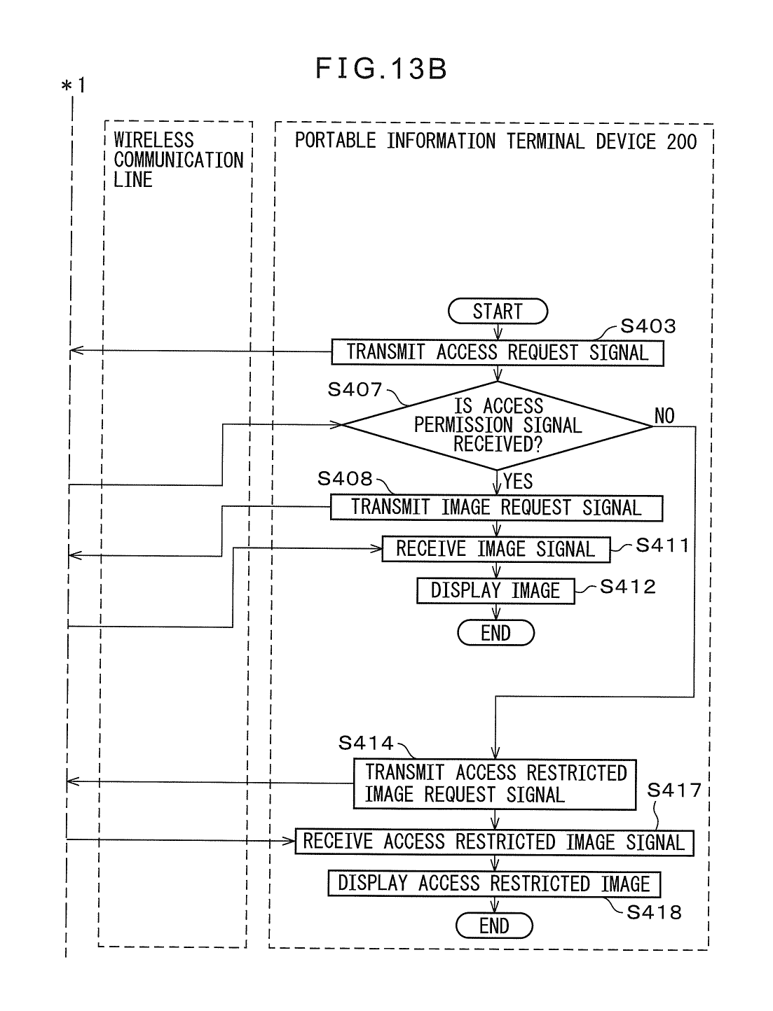

FIGS. 13A and 13B are a flowchart when access is restricted after the operation button 5 is pressed and held for a fixed period of time by an operator in the wireless communication system 100. The flow illustrated in FIGS. 13A and 13B is performed by the control unit 11 of the image reading device 1 and the terminal control unit 211 of the portable information terminal device 200 performing corresponding processing, respectively, by executing the computer programs stored in the memory 12 of the image reading device 1 and in the terminal memory 212 of the portable information terminal device 200, respectively. Steps S401 to S404 and S406 to S418 correspond to steps S201 to S204 and S206 to S218, respectively, of the flow illustrated in FIGS. 9A and 9B, and therefore, explanation thereof is omitted here.

In step S405, the image reading device 1 determines whether the number of times the operation button 5 is pressed and held is an odd number or an even number. The control unit 11 refers to information of number of times operation button is pressed stored in the memory 12 and determines that the operation button 5 is pressed and held odd number times when the information of number of times operation button is pressed indicates an odd number and the processing proceeds to step S413. On the other hand, when the information of number of times operation button is pressed indicates an even number, the control unit 11 determines that the operation button 5 is pressed and held even number times and the processing proceeds to step S405.

As described above, in the flow illustrated in FIGS. 13A and 13B, the image reading device 1 restricts access or cancels access restriction depending on the number of times the operation button 5 is pressed and held. As a result, when an operator intends to switch the security levels of access, it is possible to quickly switch the security levels of access with the portable information terminal device 200.

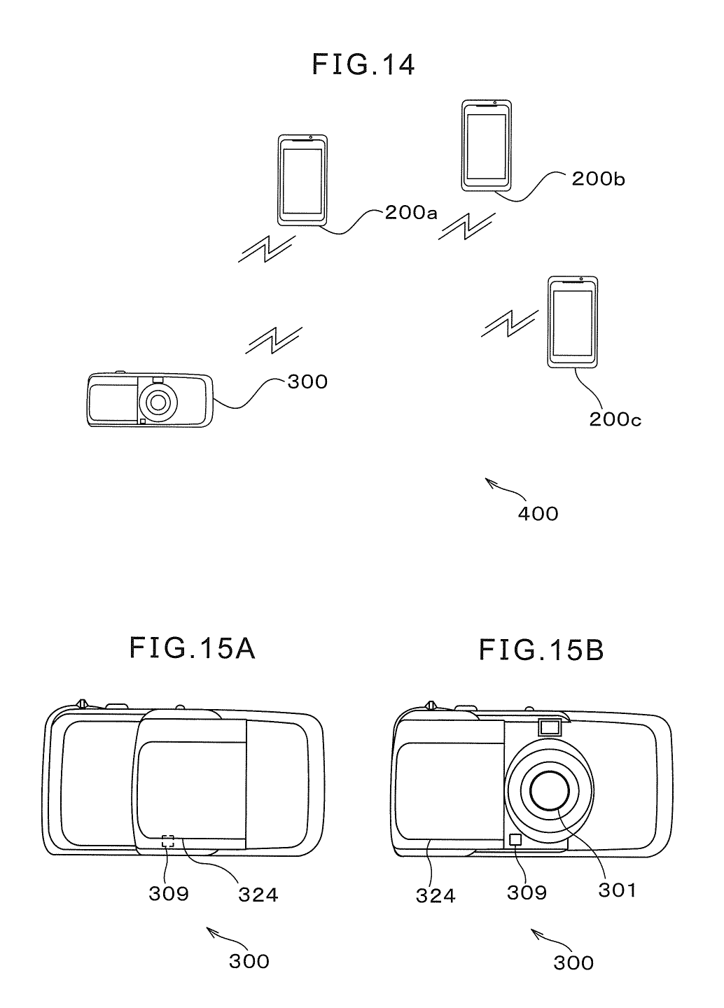

FIG. 14 is a diagram illustrating another wireless communication system 400 in which an image pickup device 300 functions as a server. The wireless communication system 400 has the image pickup device 300 that functions as a server and a plurality of portable information terminal devices 200a to 200c connected to the image pickup device 300 via a wireless communication line and which function as a client server.

FIG. 15A is a front view of the image pickup device 300 in the state where the reading function of the image pickup device 300 is disabled. FIG. 15B is a front view of the image pickup device 300 in the state where the image pickup function of the image pickup device 300 is enabled.

As illustrated in FIGS. 15A and 15B, the image pickup device 300 has an image pickup lens 301, a barrier position detection unit 309, and a barrier 324.

As illustrated in FIG. 15A, when the barrier 324 is located in the barrier closed position located in front of the image pickup lens 301, it is not possible for the image pickup device 300 to perform image pickup processing. On the other hand, as illustrated in FIG. 15B, when the barrier 324 is located in the barrier open position located in a position not in front of the image pickup lens 301, it is possible for the image pickup device 300 to perform image pickup processing. As a result, the state where the barrier 324 is located in the barrier closed position as illustrated in FIG. 15A is the state where the image pickup function of the image pickup device 300 is disabled. On the other hand, the state where the barrier 324 is located in the barrier open position as illustrated in FIG. 15B is the state where the image pickup function of the image pickup device 300 is enabled.

The barrier position detection unit 309 has a detection sensor and is arranged in the vicinity of the image pickup lens 301. The barrier position detection unit 309 detects whether the image pickup function of the image pickup device 300 is in the disabled state or in the enabled state. When the barrier 324 is located in the barrier closed position, the barrier position detection unit 309 detects proximity of the barrier 324 and transmits a barrier being closed detection signal indicting that the barrier 324 is closed to an image pickup control unit 311, to be described later.

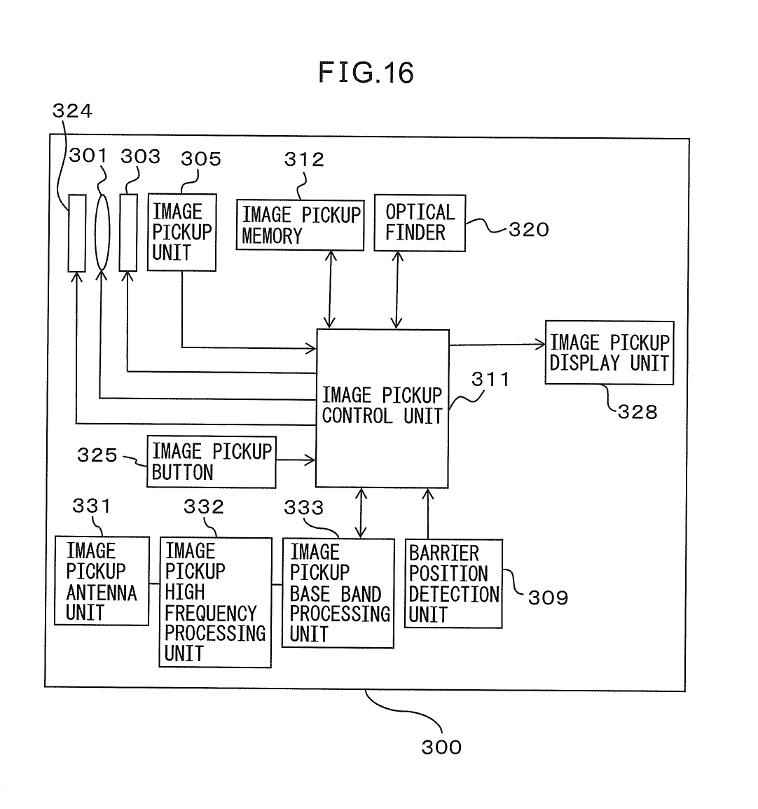

FIG. 16 is a circuit block diagram of the image pickup device 300. The image pickup device 300 further has a shutter 303, an image pickup unit 305, the image pickup control unit 311, an image pickup memory 312, an optical finder 320, an image pickup button 325, an image pickup antenna unit 331, an image pickup high frequency unit 332, an image pickup base band processing unit 333, etc.

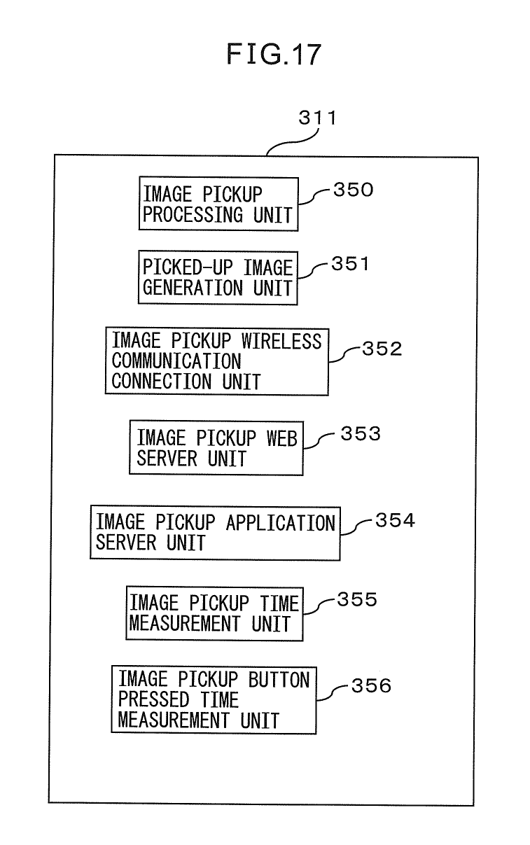

FIG. 17 is a functional block diagram of the image pickup device 300 and the image pickup control unit 311. The image pickup control unit 311 has an image pickup processing unit 350, a picked-up image generation unit 351, an image pickup wireless communication connection unit 352, an image pickup web server unit 353, and an image pickup application server unit 354. Further, the image pickup control unit 311 has an image pickup time measurement unit 355 and an image pickup button pressed time measurement unit 356.

The image pickup processing unit 350 drives the image pickup lens 301, the shutter 303, the image pickup unit 305, the optical finder 320, etc., respectively, and controls the operation of the image pickup device 300 to pick up an image and thus picks up an image.

The picked-up image generation unit 351 generates image data from an output signal of the image pickup unit 305.

The image pickup wireless communication connection unit 352, the image pickup web server unit 353, and the image pickup application server unit 354 have the same functions as the wireless communication connection unit 52, the web server unit 53, and the application server unit 54 of the image reading device 1, respectively.

The image pickup time measurement unit 355 measures the time from when the image pickup processing by the image pickup processing unit 350 is completed and when a predetermined period of time elapses, generates a time elapse signal.

The image pickup button pressed time measurement unit 356 measures the time from when that the image pickup button 325 is pressed is detected and when a predetermined period of time elapses, generates an image pickup button pressed time elapse signal. The image pickup control unit 311 cumulatively adds the number of generated image pickup button pressed time elapse signals and stores the result in the image pickup memory 312 as information of number of times image pickup button is pressed. When the information of number of times image pickup button is pressed indicates an odd number, the image pickup control unit 311 causes the image pickup web server unit 353 to transition to the complete access control mode or to the partial access control mode. When the information of the number of times the image pickup button is pressed indicates an even the number, the image pickup control unit 311 causes the image pickup web server unit 353 to make transition to the normal mode.

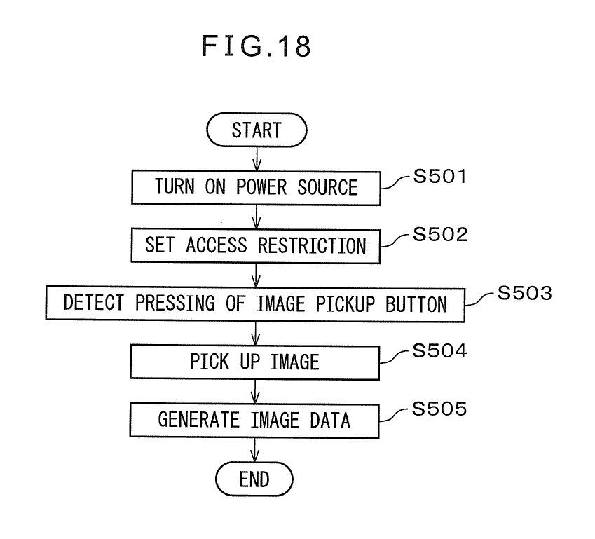

FIG. 18 is a flowchart illustrating image pickup processing by the image pickup device 300. The flow illustrated in FIG. 18 is performed by the image pickup control unit 311 of the image pickup device 300 by executing computer programs stored in the image pickup memory 312 of the image pickup device 300.

First, in S501, the power source of the image pickup device 300 is turned on. When the power source is turned on, the image pickup device 300 initializes data of a read counter, a built-in timer, an image processing work memory, etc., stored in the image pickup memory 312.

Next, in step S502, the image pickup device 300 performs various settings of access restriction. The setting of access restriction can be changed by a software button displayed on an image pickup display unit 328. When the setting relating to the access restriction is not changed, it is possible to omit the processing of step S502.

Next, in step S503, the image pickup device 300 detects that an operator has pressed the image pickup button 325. The image pickup device 300 enters the image pickup state by detecting the pressing of the image pickup button 325.

Next, in step S504, the image pickup device 300 causes the image pickup processing unit 350 to function to pick up an image.

Then, in step S505, the image pickup device 300 causes the picked-up image generation unit 351 to function to generate image data.

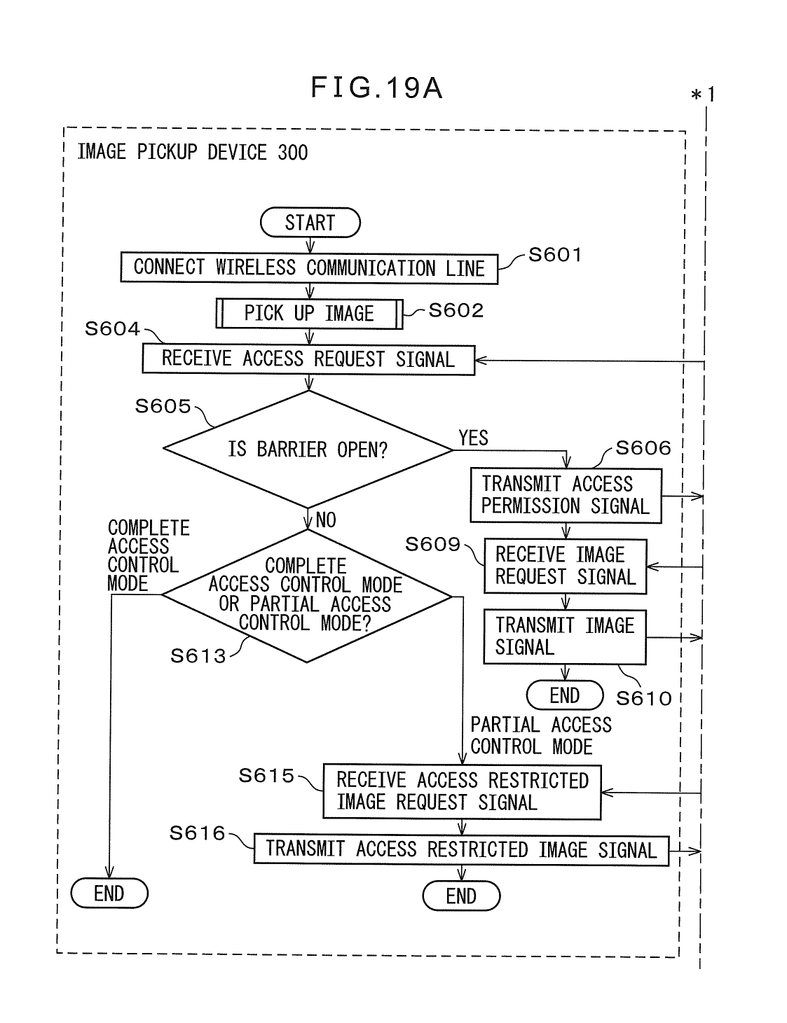

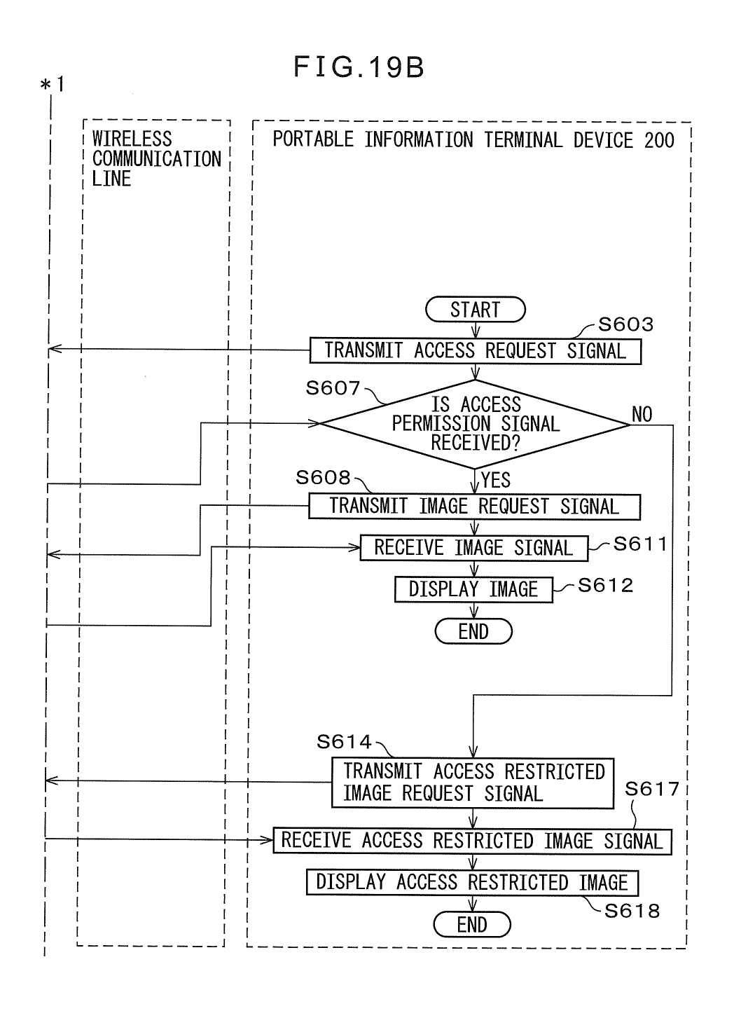

Next, with reference to FIGS. 19A and 19B, communication processing in a wireless communication system 400 in which the image pickup device 300 functions as a server and the portable information terminal device 200 as a client is explained. FIGS. 19A and 19B are a flowchart of the communication processing in the wireless communication system 400. Steps S601, S603, S604 and S606 to S618 correspond to steps S201, S203, S204 and S206 to S218 of the flow illustrated in FIGS. 9A and 9B, respectively, and therefore, explanation thereof is omitted.

In step S602, the image pickup device 300 picks up an image in accordance with the image pickup processing flow illustrated in FIG. 18. Here, by causing the image pickup processing unit 350 and the picked-up image generation unit 351 to function, respectively, the image pickup device 300 picks up an image. The image pickup device 300 stores image data corresponding to the picked-up image in the image pickup memory 312.

In step S605, the image pickup device 300 determines whether or not the barrier 324 is open. That is, the image pickup device 300 determines whether the barrier 324 is located in the barrier closed position or in the barrier open position. Here, the image pickup control unit 311 determines whether or not a barrier being closed detection signal is received from the barrier position detection unit 309 when access request information is generated in step S604. When the image pickup control unit 311 has not received the barrier being closed detection signal yet from the barrier position detection unit 309, it is determined that the barrier 324 is open and the processing proceeds to step S606. On the other hand, when the image pickup control unit 311 has received the barrier being closed detection signal from the barrier position detection unit 309, it is determined that the barrier 324 is closed and the processing proceeds to step S613.

In the flow explained with reference to FIGS. 19A and 19B, access is restricted and access restriction is cancelled in accordance with the open state and the closed state of the barrier 324 of the image pickup device 300. However, it is possible to select settings of the barrier 324 of the image pickup device 300 so that access can be restricted and access restriction can be cancelled also by other means. For example, access is restricted when a predetermined access restriction standby time elapses after picking up an image by causing the image pickup time measurement unit 355 to function. Further, access restriction is cancelled by picking up a new image in the access restriction state. Furthermore, it is possible to restrict access or cancel access restriction depending on the number of times the image pickup button 325 is pressed and held by causing the image pickup button pressed time measurement unit 356 to function. It is possible for an operator to make settings so as to cause only one of the three functions to function, i.e., the function to restrict access, the function to cancel access restriction, and the function to restrict access and cancel access restriction. Further, it is possible for an operator to make settings so as to cause any two or all of the three functions to function, i.e., the function to restrict access, the function to cancel access restriction, and the function to restrict access and cancel access restriction.

While the preferred embodiments thereof has been described, it will be appreciated that the present invention is not limited to the above specific embodiments.

For example, it may also be possible for the image reading device 1 not to have the display unit 8. When the image reading device 1 does not have the display unit 8, the QR code (registered trademark) corresponding to the communication information used to establish wireless communication is indicated on the case 2 of the image reading device 1. It may also be possible to use another information display form that the portable information terminal device 200 can read, such as a barcode, in place of the QR code (registered trademark) to be displayed or indicated. Further, the operation button 5 may be a software button displayed on the GUI of the display unit 8. In this case, by detecting an output signal of the transparent touch panel provided on the surface of the display unit 5, an input by the operation of the operation button 5 is received.

Further, it is possible to switch the settings of access restriction of the image reading device 1 not only by reading the access restriction setting sheet but also by using the setting button 281a displayed on the terminal display unit 213 of the portable information terminal device 200.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An image capturing device comprising:
an image capturing unit which captures an image;
a storage unit which stores the captured image;
a wireless communication unit which communicates with a wireless communication terminal via a wireless line;
a detector which detects a predetermined condition; and
a controller which restricts access from a wireless communication terminal while maintaining communication between the wireless communication unit and the wireless communication terminal when the detector detects the predetermined condition.

2. The image capturing device according to claim 1,
wherein communication information which establishes communication between the wireless communication unit and the wireless communication terminal is displayed on a case.

3. The image capturing device according to claim 1,
wherein the detector includes time measuring unit and the predetermined condition is the elapse of a given set period of time.

4. The image capturing device according to claim 1, further comprising a movable unit capable of moving between a first position where image capturing by the image capturing unit is enabled and a second position where image capturing by the image capturing unit is disabled,
wherein the detector includes position detecting unit which detects the position of the movable unit and the predetermined condition is the movable unit being arranged in the second position.

5. The image capturing device according to claim 1, further comprising a movable unit capable of moving between a first position where a sheet is transferred to the image capturing unit and a second position where transfer of a sheet to the image capturing unit is blocked,
wherein the detector includes position detecting unit which detects the position of the movable unit and the predetermined condition is the movable unit being arranged in the second position.

6. The image capturing device according to claim 1,
wherein the detector includes time detecting unit which detects a period of time during which a button arranged on the case is pressed and held continuously and the predetermined condition is the elapse of a given set period of time.
